(19) United States
(12) Patent Application Publication
(10) Pub. No.: US 2024/0337772 A1
(43) Pub. Date: Oct. 10, 2024

(54) METHOD FOR OBJECTIVE DETERMINATION OF TYPHOON INTENSITY BASED ON GRADIENT WIND BALANCE AND SYSTEM THEREFOR

(71) Applicants: Shanghai Typhoon Institute of the China Meteorological Administration, Shanghai (CN); Asia-Pacific Typhoon Collaborative Research Center, Shanghai (CN)

(72) Inventors: Lina Bai, Shanghai (CN); Jie Tang, Shanghai (CN); Rong Guo, Shanghai (CN); Rijin Wan, Shanghai (CN)

(21) Appl. No.: 18/433,500

(22) Filed: Feb. 6, 2024

(30) Foreign Application Priority Data
Apr. 4, 2023 (CN) 2023103473542

(51) Int. Cl. G01W 1/02

(52) U.S. Cl. CPC G01W 1/02

(57) ABSTRACT

A method and a system for objective determination of typhoon intensity based on gradient wind balance are provided. The method includes the following steps: obtaining the first position of the center of the tropical cyclone at the current moment, the second position of the center of the tropical cyclone within the preset time from the current moment, and the minimum sea level pressure; determining a movement speed of the tropical cyclone based on the first position and the second position; obtaining wind field data within the fixed area to determine the scale of the tropical cyclone; obtaining atmospheric pressure field data to determine the average environmental pressure; and obtaining an intensity of the tropical cyclone based on the first position, the minimum sea level pressure, the average environmental pressure, the scale of the tropical cyclone, and the movement speed. It enhances the accuracy and objectivity of the typhoon intensity determination.

### CROSS-REFERENCE

This application claims to the benefit of priority from Chinese Application No. 202310347354.2 with a filing date of Apr. 4, 2023. The content of the aforementioned applications, including any intervening amendments thereto, are incorporated herein by reference.

### TECHNICAL FIELD

The disclosure relates to the field of tropical cyclone intensity diagnosis technology, in particular to a method for objective determination of typhoon intensity based on gradient wind balance and a system therefor.

### BACKGROUND

Determining the intensity of a tropical cyclone is the first step in the production of tropical cyclone intensity forecasts and the issuance of tropical cyclone warnings. The accuracy of tropical cyclone intensity determination not only affects the quality of tropical cyclone intensity forecasts, but also affects the prediction of gales, rainstorms and storm surges brought by tropical cyclone. There are two indicators to measure the intensity of tropical cyclones, namely the maximum wind speed near the center of the tropical cyclone and the minimum sea level pressure at the center of the tropical cyclone. Usually, the minimum sea level pressure at the center of the tropical cyclone observed by aircraft or on the ground is the most accurate and reliable parameter to characterize the intensity of the tropical cyclone. However, the disasters caused by the tropical cyclone are often closely related to the maximum wind speed near the center, which requires objective and accurate determination of the intensity of the tropical cyclone. In the disclosure, tropical cyclone intensity specifically refers to the maximum wind speed near the center of the tropical cyclone.

At present, the minimum sea level pressure at the center of the tropical cyclone and the maximum wind speed near the center of the tropical cyclone used in typhoon operations in China are one-to-one correspondence, which is simplified based on the balance of cyclostrophic wind. The balance of cyclostrophic wind refers to the consideration of tropical cyclone center is a strong vortex motion, only consider the role of air pressure gradient force and centrifugal force, ignoring other factors such as coriolis force, friction and so on. Finally, it can only be subjectively adjusted by forecasters based on their own experience, and cannot integrate the influence of multiple factors, lacking the accuracy and objectivity of typhoon intensity determination.

### SUMMARY

In response to the shortcomings of existing methods and the needs of practical applications, in order to improve the accuracy and objectivity of typhoon intensity determination, the present invention provides a method for objective determination of typhoon intensity based on gradient wind balance in the first aspect, which includes the following steps: obtaining a first position of a center of a tropical cyclone at a current moment, a second position of the center of the tropical cyclone within a preset time from the current moment, and minimum sea level pressure of the center of the tropical cyclone at the current moment; determining a movement speed of the tropical cyclone based on the first position and the second position; obtaining wind field data within a fixed area from the center of the tropical cyclone at the current moment to determine a scale of the tropical cyclone; obtaining atmospheric pressure field data within the fixed area from the center of the tropical cyclone at the current moment to determine average environmental pressure; obtaining an intensity of the tropical cyclone based on the first position, the minimum sea level pressure, the average environmental pressure, the scale of the tropical cyclone, and the movement speed. The method of the disclosure specifically considers that the vortex motion of the center of the tropical cyclone and the tropical cyclone at higher latitudes are not applicable to a cyclostrophic wind relationship. The method for objective determination of typhoon intensity based on gradient wind balance has higher accuracy. The method of the present disclosure makes the minimum sea level pressure in the center of the same tropical cyclone no longer correspond only to the same tropical cyclone intensity, but also correspond to different tropical cyclone scales, the center of the tropical cyclone latitudes, the tropical cyclone movement speeds, and the environmental pressures, and other objective influences, so as to obtain that the minimum sea level pressure in the center of the same tropical cyclone can correspond to different tropical cyclone intensities. Meanwhile, the present disclosure can integrate the influence of multiple factors, thereby improving the accuracy and objectivity of typhoon intensity determination results.

Optionally, the movement speed of the tropical cyclone is calculated by:

$$A = 6370.949 km ; pi = 3.141592654 ;$$

$$LATP 1 = LAT 1 * pi / 180 ; LONP 1 = LON 1 * pi / 180 ;$$

$$LATP 2 = LAT 2 * pi / 180 ; LONP 2 = LON 2 * pi / 180 ;$$

$$DIS = sin ( LATP 1 ) * sin ( LATP 2 ) + cos ( LATP 1 ) * cos ( LATP 2 ) * cos ( LONP 1 - LONP 2 ) ;$$

$$SPD = ( DIS * 1000 ) / ( 12 * 3600 )$$

wherein, A denotes a radius of the earth, pi denotes a circumference ratio, LATP1 denotes a latitude of the first position, LONP1 denotes a longitude of the first position, LATP2 denotes a latitude of the second position, LONP2 denotes a longitude of the second position, DIS denotes a spherical distance between two points of the first position and the second position, and SPD denotes the movement speed.

Optionally, obtaining the scale of the tropical cyclone includes: reading the wind field data of numerical model analysis field at the current time; calculating the scale of the tropical cyclone based on the wind field data.

Optionally, the wind field data and the scale satisfy the following relationship:

$$S = \frac{{V}_{500}}{{V}_{500 C}}$$

wherein, S denotes the scale of the tropical cyclone, V₅₀₀ denotes an average wind speed at a distance of 400-600 km from the center of the tropical cyclone, and V_{500C} denotes a climatic average of V₅₀₀.

Optionally, the method for objective determination of typhoon intensity based on gradient wind balance further includes: calculating the climatic average within a preset distance from the tropical cyclone.

Optionally, the climatic average is calculated by:

$${V}_{500 C} = 1.9439 {{MSW}_{500} ( \frac{{R}_{max}}{500} )}^{x} ;$$

$$x = 0.1147 + 0.0107 {MSW}_{500} - 0.001 ( LAT 1 - 25 ) ;$$

$${R}_{max} = 66.785 - 0.1769 {MSW}_{500} + 1.0619 ( LAT 1 - 25 ) ;$$

wherein, V_{500C} denotes the climatic average of V₅₀₀, MSW₅₀₀ denotes the maximum wind speed value at the preset distance from the tropical cyclone, x denotes a calculation formula index of V_{500C}, Rₘₐₓ denotes a maximum wind speed radius, and LAT1 denotes the latitude of the first position.

Optionally, the method for objective determination of typhoon intensity based on gradient wind balance further includes:

establishing a gradient wind balance relationship.

Optionally, the gradient wind balance relationship satisfies the following formula:

$$Δ p = a + bMSW + {cMSW}^{2}$$

wherein, Δp denotes the difference between minimum sea level pressure of the center of the tropical cyclone and environmental pressure; a, b and c denote parameters, respectively; and MSW denotes the intensity of the tropical cyclone.

Optionally, the intensity of the tropical cyclone is obtained based on the first position, the minimum sea level pressure, the average environmental pressure, the scale of the tropical cyclone, and the movement speed, calculated by the following formula:

$$MSW = - 0.0002 S - 0.1349 LAT 1 + 0.1295 ( Penv - MSLP ) + 4.0317 \sqrt{( Penv - MSLP )} + 1.5 {SPD}^{0.63} + 3.3865 ;$$

wherein, MSW denotes the intensity of the tropical cyclone, S denotes the scale of the tropical cyclone, LAT1 denotes the latitude of the first position; Penv denotes the average environmental pressure, MSLP denotes the minimum sea level pressure of the center of the tropical cyclone, and SPD) denotes the movement speed of the tropical cyclone.

The second aspect, in order to efficiently execute the method for objective determination of typhoon intensity based on gradient wind balance provided by the disclosure, the disclosure further provides a system for objective determination of typhoon intensity based on gradient wind balance. The system includes a processor, an input device, an output device, and a memory; and the processor, the input device, the output device and the memory are connected to each other. Wherein the memory is configured for storing a computer program, the computer program comprises program instructions, and the processor is configured to invoke the program instructions, performing the method for objective determination of typhoon intensity based on gradient wind balance in the first aspect of the disclosure. The system for objective determination of typhoon intensity based on gradient wind balance provided in the disclosure has a compact structure with stable performance, which is capable of efficiently executing the method for objective determination of typhoon intensity based on gradient wind balance of the disclosure, enhancing the overall applicability and practical application of the disclosure.

### BRIEF DESCRIPTION OF THE DRAWINGS

FIG. 1 is the flowchart of a method for objective determination of typhoon intensity based on gradient wind balance of the present disclosure;

FIG. 2 is the structure diagram of a system for objective determination of typhoon intensity based on gradient wind balance of the present disclosure.

### DETAILED DESCRIPTION OF THE EMBODIMENTS

The specific embodiments of the present disclosure will be described in detail below. It should be noted that the embodiments described here are only for illustrative purposes and are not intended to limit the disclosure. In the following description, a large number of specific details are elaborated to provide a thorough understanding of the disclosure. However, it is obvious to the ordinary skilled person in the art that these specific details do not need to be used to implement the disclosure. In other embodiments, in order to avoid confusion with the disclosure, there is no specific description of well-known circuits, software, or methods.

Throughout the entire specification, references to “one embodiment”, “embodiment”, “one example”, or “example” imply that specific features, structures, or features described in conjunction with the embodiment or example are included in at least one embodiment of the disclosure. Therefore, the phrases “in one embodiment”, “in embodiment”, “an example”, or “example” that appear throughout the entire specification may not necessarily refer to the same embodiment or example. Besidesm specific features, structures, or characteristics can be combined in one or more embodiments or examples in any appropriate combination and/or sub combination. In addition, the ordinary skilled person in the art should understand that the illustrations provided here are for illustrative purposes and may not necessarily be drawn to scale.

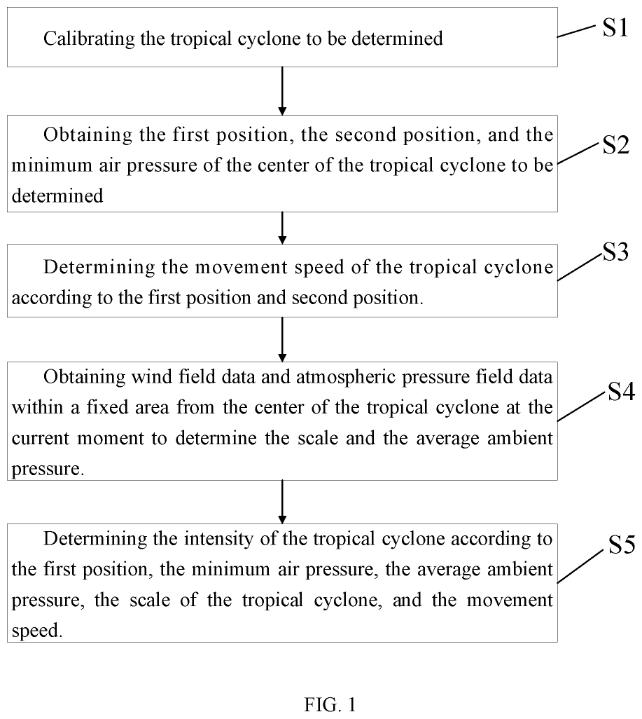

Referring to FIG. 1, in order to improve the accuracy and objectivity of typhoon intensity determination, and to integrate the influence of multiple factors, the disclosure provides a method for objective determination of typhoon intensity based on gradient wind balance. The method for objective determination of typhoon intensity based on gradient wind balance includes the following steps:
S1. calibrating the tropical cyclone to be determined.
Wherein, the tropical cyclone to be determined can be flexibly selected according to the actual experimental requirements when selecting the calibration.
S2. obtaining the first position of the center of the tropical cyclone to be determined at the current moment, the second position of the center of the tropical cyclone within the preset time from the current moment, and the minimum sea level pressure of the center of the tropical cyclone at the current moment.
Wherein, the accurate position of the center of the tropical cyclone at the current moment can be determined through satellite cloud imaging, vortex tracker technique, synthetic radar images, and ground observation station data, and the current moment can be marked as the first position. In one embodiment, the first position can be the longitude and latitude (longitude 1 and latitude 1) of the center of the tropical cyclone at the current time.

Based on this, it is also possible to obtain the second position of the center of the tropical cyclone within the preset time from the current moment through similar methods. The second position can be the longitude and latitude (longitude 2 and latitude 2) of the center of the tropical cyclone within the preset time at the current moment. Furthermore, in the embodiment, the preset time can be 12 hours before the current time, and in one or some other embodiments, the preset time can be adjusted according to specific practical needs.

Wherein, the atmospheric pressure can be measured by satellite remote sensing observation to the surface of the earth, the influence of atmospheric pressure change when the sounding meteorological ball rises, aircraft observation, and ground-based weather station observation, so as to obtain the minimum sea level pressure of the center of the tropical cyclone at the current moment. In the embodiment, the tropical cyclone to be determined is taken as the measurement object, and its value will change with the change of the calibrated tropical cyclone.

S3. determining the movement speed of the tropical cyclone according to the first position and second position. In the embodiment, the movement speed of the tropical cyclone is determined and obtained by the following formula:

$$A = 6370.949 km ; pi = 3.141592654 ;$$

$$LATP 1 = LAT 1 * pi / 180 ; LONP 1 = LON 1 * pi / 180 ;$$

$$LATP 2 = LAT 2 * pi / 180 ; LONP 2 = LON 2 * pi / 180 ;$$

$$DIS = sin ( LATP 1 ) * sin ( LATP 2 ) + cos ( LATP 1 ) * cos ( LATP 2 ) * cos ( LONP 1 - LONP 2 ) ;$$

$$SPD = ( DIS * 1000 ) / ( 12 * 3600 )$$

wherein, A denotes a radius of the earth, pi denotes a circumference ratio, LATP1 denotes a latitude of the first position, LONP1 denotes a longitude of the first position, LATP2 denotes a latitude of the second position, LONP2 denotes a longitude of the second position, DIS denotes a spherical distance between the two points of the first position and second position, and SPD denotes the movement speed.

Furthermore, the movement speed of the tropical cyclone is related to the longitude and latitude of the first position of the center of the tropical cyclone and the second position of the center of the tropical cyclone 12 hours from the current time. The movement speed of the tropical cyclone shows periodic variation with the position of the tropical cyclone. The relevant data obtained in the embodiment is true and stable, which can more accurately and objectively obtain the movement speed of the center of the tropical cyclone, providing a more reliable data source for subsequent typhoon intensity determination results.

S4. obtaining wind field data within a fixed area from the center of the tropical cyclone at the current moment to determine the scale of the tropical cyclone to be determined; obtaining atmospheric pressure field data within the fixed area from the center of the tropical cyclone at the current moment to determine the average environmental pressure.

Obtaining wind field data within a fixed area from the center of the tropical cyclone at the current moment to determine the scale of the tropical cyclone. In the embodiment, one numerical model analysis field can also be determined to analyze the embodiment, for example, the numerical model analysis field can refer to the atmospheric pressure field at a height of 10 meters above sea level at the current moment or other practical needs of the numerical model analysis field. Based on the numerical model analysis field environment, wind field data within the fixed area from the center of the tropical cyclone is collected.

$$S = \frac{{V}_{500}}{{V}_{500 C}}$$

Obtaining wind field data near the center of the tropical cyclone within the fixed area and determining the scale of the tropical cyclone. Wherein, taking the annular region 400 to 600 km from the center of the tropical cyclone as the collection range of the wind field data. In the embodiment, wind field data can be obtained according to the numerical model analysis field, and the scale of the center of the tropical cyclone can be determined through calculation. The calculation formula is as follows:

wherein, S denotes the scale of the tropical cyclone, V₅₀₀ denotes the average wind speed at the distance of 400-600 km from the center of the tropical cyclone, and V_{500C} denotes the climatic average of V₅₀₀. Furthermore, in the embodiment, the fixed area is set as an annular region 400 to 600 kilometers from the center of the tropical cyclone. In one or some other embodiments, the scale and shape of the fixed area can be adjusted and modified according to specific practical needs to ensure the objectivity and accuracy of data acquisition.

Wherein, V_{500C} denotes the climatic average of V₅₀₀ in step S4, for the acquisition of V_{500C}, it is necessary to input the maximum wind speed value of the first position of the center of the tropical cyclone and the fixed area at the current time. In the embodiment, the first position is latitude 1 of the center of the tropical cyclone at the current moment, and the annular region 400 to 600 km from the center of the tropical cyclone is used as a place for measuring the maximum wind speed value.

In the embodiment V_{500C} is obtained by the following formula:

$${V}_{500 C} = 1.9439 {{MSW}_{500} ( \frac{{R}_{max}}{500} )}^{x} ;$$

$$x = 0.1147 + 0.0107 {MSW}_{500} - 0.001 ( LAT 1 - 25 ) ;$$

$${R}_{max} = 66.785 - 0.1769 {MSW}_{500} + 1.0619 ( LAT 1 - 25 ) ;$$

wherein, V_{500C} denotes the climatic average of V₅₀₀, MSW₅₀₀ denotes the maximum wind speed value at the preset distance from the tropical cyclone, x denotes the calculation formula index of V_{500C}, Rₘₐₓ denotes the maximum wind speed radius, and LAT1 denotes the first position. In the embodiment, the smaller the maximum wind speed value in the area 400-600 km away from the center of the tropical cyclone, the larger the value of the maximum wind speed radius. The average climate value is direct proportion to the maximum wind speed value, the maximum wind speed radius, and the calculation formula index x. In the embodiment, the fixed area is defined as an annular region 400-600 km from the center of the tropical cyclone. In other specific embodiments, the scope, shape, and scene of the fixed area can be adjusted and changed according to specific practical needs. The disclosure uses the data within the fixed area and the dynamic change data of the climatic average of V₅₀₀ and the maximum wind speed radius to obtain the central scale of the tropical cyclone at different times, which can synthesize the influence of various factors and improve the objectivity and accuracy of the data.

Based on the pattern analyze field, obtaining atmospheric pressure field data within the fixed area from the center of the tropical cyclone at the current moment to determine the average environmental pressure.

In the embodiment, the fixed area is set as an annular region 800 to 1000 km from the center of the tropical cyclone, and the average air pressure value within the annular region 800 to 1000 km from the center of the tropical cyclone is calculated based on atmospheric pressure field data, which is regarded as the average environmental pressure.

Furthermore, in the embodiment, the fixed area is set as an annular region 800 to 1000 km from the center of the tropical cyclone in the numerical model analysis field environment. In one or some other embodiments, the site environment, delineation range, area shape, and other conditions can be adjusted according to specific practical needs to ensure the accuracy of the obtaining values, thereby improving the practicality of the method.

S5. determining the intensity of the tropical cyclone according to the first position, the minimum sea level pressure, the average environmental pressure, the scale of the tropical cyclone, and the movement speed.

The scale of the calibrated tropical cyclone center to be determined, the latitude 1 of the first position where the center of the tropical cyclone is located, the average environmental pressure, the movement speed of the tropical cyclone, the maximum wind speed of the center of the tropical cyclone, and the minimum sea level pressure of the center of the tropical cyclone are taken into the formula to obtain the maximum wind speed near the center of the tropical cyclone at this time. In the embodiment, the maximum wind speed value is calculated. The calculation formula is as follows:

$$MSW = - 0.0002 S - 0.1349 LAT 1 + 0.1295 ( Penv - MSLP ) + 4.0317 \sqrt{( Penv - MSLP )} + 1.5 {SPD}^{0.63} + 3.3865 ;$$

wherein, MSW denotes the intensity of the tropical cyclone, S denotes the scale of the tropical cyclone, LAT1 denotes the first position, Penv denotes the average environmental pressure, MSLP denotes the minimum sea level pressure of the center of the tropical cyclone, and SPD denotes the movement speed of the tropical cyclone.

In the embodiment, the gradient wind balance relationship is established based on the pressure gradient force, the centrifugal force, and the coriolis force. Furthermore, the gradient wind balance relationship can be approximated by radial integrals as follows:

$$Δ p = a + bMSW + {cMSW}^{2}$$

wherein, Δp denotes the difference between the minimum sea level pressure of the center of the tropical cyclone and the environmental pressure; a, b and c denote parameters, respectively; and MSW denotes the intensity of the tropical cyclone.

In the gradient wind balance relationship, the pressure gradient force refers to the force acting on the unit mass of air due to uneven spatial pressure distribution; centrifugal force refers to a virtual force, which is a manifestation of inertia that moves a rotating object away from its center of rotation; and the coriolis force is a description of the linear motion deviation of a mass point in a rotating system due to inertia relative to the rotating system.

In the embodiment, the gradient wind balance relationship applies radial integrals, and the parameters a, b, and c in the integration relationship can be obtained through the statistical regression method. In other embodiments and practical analysis, different transformation applications can be applied to the gradient wind balance relationship, thereby improving the applicability and authenticity of the data. Furthermore, in the present embodiment, the significant impact of the movement of the position of the center of the tropical cyclone and changes in higher latitudes on the value of coriolis force is considered, as well as the influence of objective factors such as the tropical cyclone radius, the air density, the air pressure, and the tangential wind speed on the maximum wind speed of the center of the tropical cyclone. Furthermore, adopting an approximate transformation of the gradient wind balance relationship can comprehensively consider the objective effects of multiple factors, compensate for the shortcomings of subjective judgment and single result of the cyclostrophic wind balance relationship method, improve the accuracy and objectivity of typhoon intensity determination, and be more conducive to practical application.

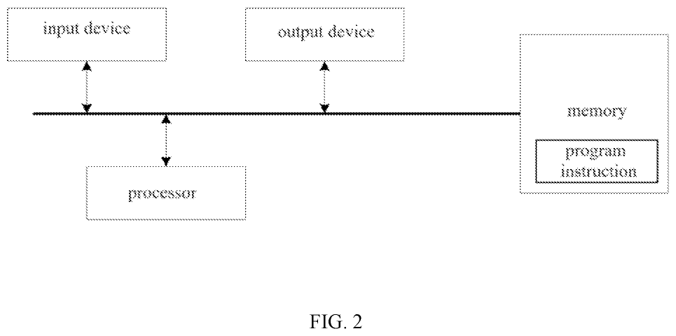

Referring to FIG. 2, in an optional embodiment, in order to efficiently execute the method for objective determination of typhoon intensity based on gradient wind balance provided by the present disclosure, it further provides a system for objective determination of typhoon intensity based on gradient wind balance. The system for objective determination of typhoon intensity based on gradient wind balance includes a processor, an input device, an output device, and a memory; and the processor, the input device, the output device and the memory are connected to each other. Wherein the memory is configured for storing a computer program, the computer program comprises program instructions, and the processor is configured to invoke the program instructions, performing specific steps of the relevant embodiment of the method for objective determination of typhoon intensity based on gradient wind balance provided in the present disclosure. The system for objective determination of typhoon intensity based on gradient wind balance provided in the disclosure has a compact structure with stable performance, which is capable of efficiently executing the method for objective determination of typhoon intensity based on gradient wind balance of the present disclosure, enhancing the overall applicability and practical application of the present disclosure.

Finally, it should be noted that the above embodiments are only used to illustrate the technical solution of the present disclosure, and not to limit it. Although the present disclosure has been described in detail with reference to the aforementioned embodiments, the ordinary skilled person in the art should understand that they can still modify the technical solutions recorded in the aforementioned embodiments, or equivalently replace some or all of the technical features. These modifications or replacements do not make the essence of the corresponding technical solutions depart from the scope of the technical solutions of the various embodiments of the present disclosure, and they should all be covered within the scope of the claims and specifications of the present disclosure.

What is claimed is:

1. A method for objective determination of typhoon intensity based on gradient wind balance, comprising the following steps:
obtaining a first position of a center of a tropical cyclone at a current moment, a second position of the center of the tropical cyclone within a preset time from the current moment, and minimum sea level pressure of the center of the tropical cyclone at the current moment; wherein the first position is a first longitude and a first latitude of the center of the tropical cyclone at the current time, the second position is a second longitude and a second latitude of the center of the tropical cyclone within the preset time at the current moment, and the first position and the second position are obtained through satellite cloud imaging;
determining, by a processor, a movement speed of the tropical cyclone based on the first position and the second position; wherein the movement speed of the tropical cyclone is calculated by:
$$A = 6370.949 km ; pi = 3.141592654 ;$$
$$LATP 1 = LAT 1 * pi / 180 ; LONP 1 = LON 1 * pi / 180 ;$$
$$LATP 2 = LAT 2 * pi / 180 ; LONP 2 = LON 2 * pi / 180 ;$$
$$DIS = sin ( LATP 1 ) * sin ( LATP 2 ) + cos ( LATP 1 ) * cos ( LATP 2 ) * cos ( LONP 1 - LONP 2 ) ;$$
$$SPD = ( DIS * 1000 ) / ( 12 * 3600 )$$
wherein A denotes a radius of the earth, pi denotes a circumference ratio, LATP1 denotes a latitude of the first position, LONP1 denotes a longitude of the first position, LATP2 denotes a latitude of the second position, LONP2 denotes a longitude of the second position, DIS denotes a spherical distance between two points of the first position and the second position, SPD denotes the movement speed, LAT1 denotes degrees corresponding to the latitude of the first position, LAT2 denotes degrees corresponding to the latitude of the second position, LON1 denotes degrees corresponding to the longitude of the first position, and LON2 denotes degrees corresponding to the longitude of the second position;
obtaining wind field data within a fixed area from the center of the tropical cyclone at the current moment to determine a scale of the tropical cyclone, wherein obtaining the scale of the tropical cyclone comprising: reading the wind field data of numerical model analysis field at the current time; calculating the scale of the tropical cyclone based on the wind field data;
obtaining atmospheric pressure field data within the fixed area from the center of the tropical cyclone at the current moment to determine average environmental pressure;
wherein the atmospheric pressure field data are measured by a satellite through remote sensing observation, so as to obtain the minimum sea level pressure of the center of the tropical cyclone at the current moment;
obtaining an intensity of the tropical cyclone based on the first position, the minimum sea level pressure, the average environmental pressure, the scale of the tropical cyclone, and the movement speed, calculated by the following formula:
$$MSW = - 0.0002 S - 0.1349 LAT 1 + 0.1295 ( Penv - MSLP ) + 4.0317 \sqrt{( Penv - MSLP )} + 1.5 {SPD}^{0.63} + 3.3865 ;$$
wherein MSW denotes the intensity of the tropical cyclone, unit in m/s; S denotes the scale of the tropical cyclone, unit in km; Penv denotes the average environmental pressure, unit in hPa; MSLP denotes the minimum sea level pressure of the center of the tropical cyclone, unit in hPa; and SPD denotes the movement speed of the tropical cyclone, unit in m/s;
establishing a gradient wind balance relationship, by the processor, the gradient wind balance relationship satisfies the following formula:
$$Δ p = a + bMSW + {cMSW}^{2}$$
wherein Δp denotes the difference between minimum sea level pressure of the center of the tropical cyclone and environmental pressure; a, b and c denote parameters, respectively; and MSW denotes the intensity of the tropical cyclone;
the gradient wind balance relationship applies radial integrals, and the parameters a, b, and c in the integration relationship are obtained through the statistical regression method.

2-3. (canceled)

4. The method for objective determination of typhoon intensity based on gradient wind balance according to claim 3, wherein the wind field data and the scale satisfy the following relationship:
$$S = \frac{{V}_{500}}{{V}_{500 C}}$$
wherein S denotes the scale of the tropical cyclone, V₅₀₀ denotes an average wind speed at a distance of 400-600 km from the center of the tropical cyclone, and V_{500C} denotes a climatic average of V₅₀₀.

5. The method for objective determination of typhoon intensity based on gradient wind balance according to claim 1, further comprising:
calculating the climatic average within a preset distance from the tropical cyclone.

6. The method for objective determination of typhoon intensity based on gradient wind balance according to claim 5, wherein the climatic average is calculated by:
$${V}_{500 C} = 1.9439 {{MSW}_{500} ( \frac{{R}_{max}}{500} )}^{x} ;$$
$$x = 0.1147 + 0.0107 {MSW}_{500} - 0.001 ( LAT 1 - 25 ) ;$$
$${R}_{max} = 66.785 - 0.1769 {MSW}_{500} + 1.0619 ( LAT 1 - 25 ) ;$$
wherein V_{500C} denotes the climatic average of V₅₀₀, unit in m/s; MSW₅₀₀ denotes the maximum wind speed value at the preset distance from the tropical cyclone, unit in km; x denotes a calculation formula index of V_{500C}; Rₘₐₓ denotes a maximum wind speed radius, unit in km; and LAT1 denotes the degrees corresponding the latitude of the first position, unit in °.

7-9. (canceled)

10. A system for objective determination of typhoon intensity based on gradient wind balance, comprising the processor, an input device, an output device, and a memory, wherein the processor, the input device, the output device and the memory are connected to each other; the memory is configured for storing a computer program; the computer program comprises program instructions, and the processor is configured to invoke the program instructions to execute the method for objective determination of typhoon intensity based on gradient wind balance according to claim 1.
